(19) United States
(12) Patent Application Publication
(10) Pub. No.: US 2023/0134222 A1
(43) Pub. Date: May 4, 2023

(54) Artificial Waterproof Granular Material and Method for Making the Same

(71) Applicant: NINGBO JUNXING TOYS AND TECHNOLOGY CO., LTD, Zhejiang (CN)

(72) Inventor: Weibo Yan, Zhejiang (CN)

(21) Appl. No.: 17/952,638

(22) Filed: Sep. 26, 2022

(30) Foreign Application Priority Data
Nov. 4, 2021 (CN) 202111301086.8

(51) Int. Cl. C08J 3/12; C08K 3/36; C08K 5/00; C08K 5/02; C08K 5/5419; C08K 5/3417; C08K 5/3492

(52) U.S. Cl. CPC C08J 3/126; C08K 3/36; C08K 5/005; C08K 5/02; C08K 5/5419; C08K 5/3417; C08K 5/3492; C08J 2375/08; C08K 2201/014

(57) ABSTRACT

The present disclosure relates to an artificial waterproof granular material and a method for making the same. The granular material is formed from the following ingredients in parts by weight: 4.5 to 9.5 parts of a polyurethane resin, 3 to 5 parts of a modified polyurethane resin, 90 to 95 parts of a filler, 0.3 to 0.7 parts of a plasticizer, 0.3 to 0.7 parts of a coupling agent, 0.1 to 0.8 parts of a coloring agent, 1.5 to 2.5 parts of a metal organic frameworks material Ag-MOFs, and 0.5 to 2.0 parts of an additional additive.

### CROSS-REFERENCE TO RELATED APPLICATIONS

This application claims all benefits accruing under 35 U.S.C. § 119 from China Patent Application No. 202111301086.8 filed on Nov. 4, 2021 in the China National Intellectual Property Administration, the contents of which are incorporated by reference herein.

### TECHNICAL FIELD

The present disclosure relates to the technical field of toys, in particular to an artificial waterproof granular material and a method for making the same.

### BACKGROUND

With the continuous development of urbanization and the improvement of people's quality of life, children like to play in the playgrounds set up in various squares or shopping malls, and the toys which are continuously updated are very attractive to them and well stimulate their curiosity. The natural sand such as the beach sand has good fluidity but poor plasticity, so it is difficult to be manually moulded into various unique shapes by the children. The plasticine has good plasticity but poor fluidity, and is difficult to be cleaned after being blended with other toys. An artificial granular material (for example, kinetic sand) which combines the advantages of the natural sand and the plasticine has been developed. Such artificial granular material has both the good fluidity and the good plasticity, thereby meeting the requirements of children's play and long-term use.

However, the existing artificial granular material either has poor waterproofness, would become sticky in case of touching sweat or water stains, have a requirement for humidity in the air (if the humidity is too high, the material should be air-dried), and would be dispersed when exposed to water; or has problems such as poor resistances to humidity, heat, bacteria, and rubbing, thus not meeting the requirement for long-term use in the field of toys.

### SUMMARY

In view of the above, to solve the problem that the existing artificial granular material has poor waterproofness and poor resistances to humidity, heat, bacteria, and rubbing, the present disclosure provides an artificial waterproof granular material which can meet the requirement for long-term use in the field of toys.

An artificial waterproof granular material is formed from the following ingredients in parts by weight: 4.5 to 9.5 parts of a polyurethane resin, 3 to 5 parts of a modified polyurethane resin, 90 to 95 parts of a filler, 0.3 to 0.7 parts of a plasticizer, 0.3 to 0.7 parts of a coupling agent, 0.1 to 0.8 parts of a coloring agent, 1.5 to 2.5 parts of a metal organic frameworks material Ag-MOFs, and 0.5 to 2.0 parts of an additional additive.

In an embodiment, the modified polyurethane resin is obtained by a polymerization reaction with polyethylene glycol, 1H,1H,9H,9H-perfluoro-1,9-nonanediol, and 4,4′-diphenylmethane diisocyanate as monomer ingredients and ethanediol as a chain extender in the presence of a catalyst.

In an embodiment, the filler is selected from the group consisting of polyacrylonitrile plastic particle, ethylene-vinyl acetate copolymer particle, polystyrene particle, titanium dioxide, quartz sand, river sand, sea sand, silica sand, glass bead, glass sand, polyvinyl chloride particle, silicone hollow microsphere, ground marble, hollow microspheres, plastic microspheres, ceramic microspheres, glass microspheres, and any combination thereof.

In an embodiment, the plasticizer is a blend of chlorinated paraffin, mineral oil, and an ester plasticizer.

In an embodiment, the ester plasticizer is selected from the group consisting of terephthalate, phosphate, cyclohexanedicarboxylate, polyol ester, phthalate or any combination thereof.

In an embodiment, the ester plasticizer is selected from the group consisting of dioctyl terephthalate, tris(2-ethylhexyl) phosphate, diisononyl 1,2-cyclohexanedicarboxylate, 2,2,4-trimethyl-1,3-pentanediol diisobutyrate, diethylene glycol dibenzoate, butyl benzyl phthalate, and any combination thereof.

In an embodiment, a mass ratio of the chlorinated paraffin, the mineral oil, and the ester plasticizer is in a range of (2.5-3.5):(0.8-1.2):(0.8-1.2).

In an embodiment, the coupling agent is selected from the group consisting of heptafluoroalkyltrimethoxysilane, heptafluoroalkyltriethoxysilane, tridecafluoroalkyltrimethoxysilane, tridecafluoroalkyltriethoxysilane, dodecafluoroalkyltrimethoxysilane, dodecafluoroalkyltriethoxysilane, and any combination thereof.

In an embodiment, the coloring agent is selected from the group consisting of phthalocyanine blue, fluorescent green, cochineal red, gamboge, alizarin red, indigo, lemon yellow, roselle red, carbon black, titanium dioxide, and any combination thereof.

In an embodiment, the additional additive is selected from the group consisting of an antioxidant, a preservative, a polyhedral oligomeric silsesquioxane, and any combination thereof.

In an embodiment, the Ag-MOFs is self-assembled by 2,4,6-tris(4-carboxyphenoxy)-1,3,5-triazine and Ag ions via coordinate bonds.

In another aspect of the present disclosure, a method for making the artificial waterproof granular material is provided, comprising:

mixing 3 to 5 parts by weight of a modified polyurethane resin, 4.5 to 9.5 parts by weight of a polyurethane resin, and 0.3 to 0.7 parts by weight of a coupling agent to obtain a resin mixture;

adding 90 to 95 parts by weight of a filler, 1.5 to 2.5 parts by weight of a Ag-MOFs material, 0.3 to 0.7 parts by weight of a coupling agent, 0.1 to 0.8 parts by weight of a coloring agent, and 0.5 to 2.0 parts by weight of an additional additive into the resin mixture to obtain an ingredient mixture; and

subjecting the ingredient mixture to a ball milling reaction for 1 to 8 hours followed by a spray granulation to obtain the artificial waterproof granular material.

The artificial waterproof granular material has not only good waterproofness and good resistances to humidity and heat, but also excellent antibacterial property and rubbing resistance, meeting the requirement for long-term use in the field of toys.

### DETAILED DESCRIPTION

The present disclosure will now be described in detail with reference to embodiments in order to make the objects, technical solutions, and advantages of the present disclosure more clear. It should be understood that the specific embodiments described herein are only for explaining the present disclosure, and not intended to limit the present disclosure.

An artificial waterproof granular material is provided. The granular material is formed from the following ingredients in parts by weight: 4.5 to 9.5 parts of a polyurethane resin, 3 to 5 parts of a modified polyurethane resin, 90 to 95 parts of a filler, 0.3 to 0.7 parts of a plasticizer, 0.3 to 0.7 parts of a coupling agent, 0.1 to 0.8 parts of a coloring agent, 1.5 to 2.5 parts of a metal organic frameworks material Ag-MOFs, and 0.5 to 2.0 parts of an additional additive.

The polyurethane resin can be a thermoplastic polyurethane, in particular a thermoplastic polyether-type polyurethane.

The modified polyurethane resin can be obtained by a polymerization reaction with polyethylene glycol, 1H,1H,9H,9H-perfluoro-1,9-nonanediol, and 4,4′-diphenylmethane diisocyanate as monomer ingredients and ethanediol as a chain extender in the presence of a catalyst. The perfluoro modified polyurethane resin has a good compatibility with the polyurethane resin and can improve the waterproofness of the filler granule coated by the polyurethane resin, so that the shape moulded from the granular material can be maintained and the granules in the granular material are not dispersed in case of touching water.

The filler can be a particulate/granular filler. The filler can be selected from the group consisting of polyacrylonitrile plastic particle, ethylene-vinyl acetate copolymer particle, polystyrene particle, titanium dioxide particle, quartz sand, river sand, sea sand, silica sand, glass bead, glass sand, polyvinyl chloride particle, silicone hollow microsphere, ground marble, hollow microspheres, plastic microspheres, ceramic microspheres, glass microspheres and any combination thereof. It should be understood that many other materials are also possible, such as humus, sawdust, grass powder, straw, starch, and any combination thereof.

The plasticizer can be a blend of chlorinated paraffin (for example, available from INEOS Chlor), mineral oil, and an ester plasticizer. The blend plasticizer in the present disclosure can effectively soften the polyurethane resin and thus facilitate the coating of the polyurethane resin onto the filler, which improves the workability of the artificial waterproof granular material.

The ester plasticizer can be terephthalate such as dioctyl terephthalate (DOTP), phosphate such as tris(2-ethylhexyl) phosphate (TEHP), cyclohexanedicarboxylate such as diisononyl 1,2-cyclohexanedicarboxylate (DINCH), polyol ester such as 2,2,4-trimethyl-1,3-pentanediol diisobutyrate (TXIB) and diethylene glycol dibenzoate (DEDB), and phthalate such as butyl benzyl phthalate.

A mass ratio of the chlorinated paraffin, mineral oil, and the ester plasticizer can be in a range of (2.5-3.5):(0.8-1.2):(0.8-1.2), for example, about 3:1:1.

The coupling agent can be a fluorine-containing silane coupling agent. The fluorine-containing silane coupling agent can be selected from the group consisting of heptafluoroalkyltrimethoxysilane, heptafluoroalkyltriethoxysilane, tridecafluoroalkyltrimethoxysilane, tridecafluoroalkyltriethoxysilane, dodecafluoroalkyltrimethoxysilane, dodecafluoroalkyltriethoxysilane, and any combination thereof. The fluorine-containing silane coupling agent can improve the hydrophobicity of the surfaces of the granules of the granular material and reduce the penetration of water molecules in the environment into the granular material, thereby improving the waterproofness and the heat and humidity resistances of the granular material.

The coloring agent can be any suitable coloring agent, for example, can be selected from the group consisting of phthalocyanine blue, fluorescent green, cochineal red, gamboge, alizarin red, indigo, lemon yellow, roselle red, carbon black, titanium dioxide, and any combination thereof.

The additional additive can be selected from the group consisting of an antioxidant, a preservative, a polyhedral oligomeric silsesquioxane, and any combination thereof.

The antioxidant can be a hindered phenol antioxidant. The hindered phenol antioxidant can be selected from the group consisting of hindered phenol antioxidant 1010, hindered phenol antioxidant 3114, hindered phenol antioxidant 1076, and any combination thereof. The hindered phenol antioxidant have the advantages of no discoloration, no pollution, and good aging resistance and thermal stability.

The preservative can be selected from the group consisting of potassium sorbate, ascorbic acid, sodium benzoate, and any combination thereof. The addition of the preservative can further inhibit the health risks caused by the growth of bacteria on the surfaces of the granules, and prolong the service life of the waterproof granular material.

The polyhedral oligomeric silsesquioxane (POSS) has a formula of (RSiO_{3/2})n, wherein R is an organic group and each of Si atoms located at eight corners of the POSS is linked to one R. The POSS can be, for example, perfluoro-group-containing POSS in which R is dodecafluoro heptyl propyl and which can be made by the hydrolysis-polycondensation of dodecafluoro heptyl propyl trimethoxy silane at the temperature of 60 to 90° C. in the presence of acid catalyst such as nitric acid. Due to the unique organic-inorganic hybrid properties and polyhedral structure characteristics of the polyhedral oligomeric silsesquioxane, in combination with the unique property of perfluoro group, the waterproof granular material has the characteristics of anti-adhesion, hydrophobicity and oleophobicity, as well as excellent heat and humidity resistances and rubbing resistance.

The Ag-MOFs is a metal-organic frameworks (MOFs) material with 2,4,6-tris(4-carboxyphenoxy)-1,3,5-triazine as an organic MOF ligand. The Ag-MOFs in the present disclosure is self-assembled by 2,4,6-tris(4-carboxyphenoxy)-1,3,5-triazine and Ag ions via coordinate bonds. The organic MOF ligand, which has multiple carboxy groups, can be coordinated and self-assembled with Ag ions to form a network structure. The use of the Ag-MOFs allows the Ag ions to be uniformly distributed in the waterproof granular material, thereby improving the antibacterial property of the whole waterproof granular material. Moreover, the triazine structure in the center of the MOF is helpful to improve the weather resistance and flame retardant property of the waterproof granular material. As a result, the waterproof granular material can have a long serve-life in any grueling condition.

In another aspect of the present disclosure, a method for making the above-described artificial waterproof granular material is provided, comprising the following steps:
S1, providing the modified polyurethane resin;
S2, providing the Ag-MOFs material;
S3, weighing 3 to 5 parts of the modified polyurethane resin, 4.5 to 9.5 parts of the polyurethane resin, and 0.3 to 0.7 parts of the coupling agent and heating and stirring them uniformly to obtain a resin mixture, adding 90 to 95 parts of the filler, 1.5 to 2.5 parts of the Ag-MOFs material, 0.3 to 0.7 parts of the coupling agent, 0.1 to 0.8 parts of the coloring agent, and 0.5 to 2.0 parts of the additional additive into the resin mixture to obtain an ingredient mixture, and subjecting the ingredient mixture to a ball milling reaction for 1 to 8 h followed by a spray granulation to obtain the artificial waterproof granular material.

In S1, the modified polyurethane resin can be obtained as follows. 10 to 15 parts of polyethylene glycol, 3 to 7 parts of ethylene glycol, 2 to 3 parts of 1H,1H,9H,9H-perfluoro-1,9-nonanediol, and 1 to 5 parts of triethylenediamine are weighted, mixed uniformly by stirring, heated to a temperature of 65 to 95° C., and slowly dropwise-added with an appropriate amount of diphenylmethane diisocyanate. Then the temperature is kept and a reaction is carried out until the weight percentage of —NCO reaches zero, thereby obtaining the modified polyurethane resin.

In S2, the Ag-MOFs material can be obtained as follows. The organic MOF ligand is dissolved into 1 L of a solvent dimethylformamide (DMF) to a concentration of 0.05 to 0.15 mol/L, and then mixed with 1 to 1.1 L of an aqueous solution of silver nitrate in a concentration of 0.15 to 0.45 mol/L, thereby obtaining a liquid mixture. The liquid mixture is subjected to a reflux condensation reaction at 110 to 160° C. for 6 to 12 hours, cooled to room temperature, filtered, repeatedly washed with acetone, and dried to obtain the Ag-MOFs material. The organic MOF ligand is 2,4,6-tris(4-carboxyphenoxy)-1,3,5-triazine of a formula I:

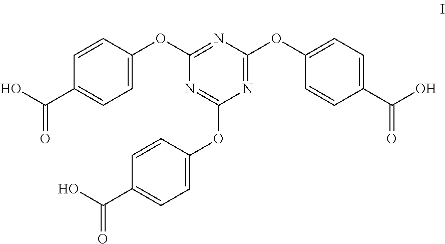 [SMILES: O=C(O)c1ccc(Oc2nc(Oc3ccc(C(=O)O)cc3)nc(Oc3ccc(C(=O)O)cc3)n2)cc1]

The artificial waterproof granular material in the present disclosure comprising a plurality of granules. Each granule comprises a core and a cohesive layer coated on the core. The granules are attachable to each other via the cohesive layers thereof. The granules attached to each other as a whole is flowable, mouldable, compressible, and kneadable. The granules can be pressed together with one's hands to form a self supporting configuration. The core is formed by the filler as described above. The cohesive layer is formed by the polyurethane resin, modified polyurethane resin, the plasticizer, the coupling agent, the coloring agent, the metal organic frameworks material Ag-MOFs, and the additional additive as described above. The granules can have an average size of 0.5 mm to 1.5 mm.

Due to the excellent waterproofness of the granular material. The granular material maintains its flowable, mouldable, compressible, and kneadable properties even in the water, with the granules thereof undispersed.

### Example 1

In this example, an artificial waterproof granular material is formed from the following ingredients in part by weight: 4.5 parts of a polyurethane resin, 3 parts of a modified polyurethane resin, 90 parts of a filler, 0.3 parts of a plasticizer, 0.3 parts of a coupling agent, 0.1 parts of a coloring agent, 1.5 parts of a Ag-MOFs (metal organic frameworks material), and 0.5 parts of an additional additive.

The filler is the quartz sand. The plasticizer is a blend of chlorinated paraffin, mineral oil, and butyl benzyl phthalate in a mass ratio of 3:1:1. The coupling agent is heptadecafluoroalkyltrimethoxysilane. The coloring agent is phthalocyanine blue. The additional additive is perfluoro-group-containing polyhedral oligomeric silsesquioxane.

In this example, the method for making the artificial waterproof granular material comprises the following steps.

Step S1: 10 parts of polyethylene glycol, 3 parts of ethylene glycol, 2 parts of 1H,1H,9H,9H-perfluoro-1,9-nonanediol, and 1 part of triethylenediamine are weighed in parts by weight, stirred to be mixed uniformly, heated to a temperature of 80° C., and slowly dropwise added with an appropriate amount of diphenylmethane diisocyanate, and then the temperature is kept until the percentage by weight of —NCO reaches zero, to obtain the modified polyurethane.

Step S2: 2,4,6-tris(4-carboxyphenoxy)-1,3,5-triazine of formula I, as an organic MOF ligand, is dissolved into 1 L of solvent dimethylformamide (DMF) to a concentration of 0.05 mol/L, and then mixed with 1.1 L of aqueous solution of silver nitrate in a concentration of 0.15 mol/L, thereby obtaining a liquid mixture. The liquid mixture is subjected to a reflux condensation reaction at 130° C. for 6 hours, cooled to room temperature, filtered, repeatedly washed with acetone, and dried to obtain the Ag-MOFs material.

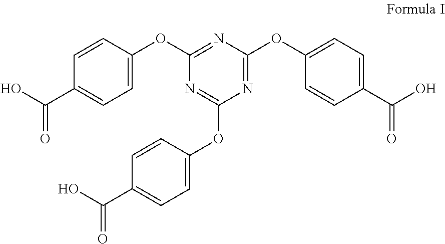 [SMILES: O=C(O)c1ccc(Oc2nc(Oc3ccc(C(=O)O)cc3)nc(Oc3ccc(C(=O)O)cc3)n2)cc1]

Step S3: 3 parts of the modified polyurethane resin obtained in step 51, 4.5 parts of the polyurethane resin, and 0.3 parts of the plasticizer are weighed in parts by weight, mixed uniformly, and then added with 90 parts of the filler, 1.5 parts of the Ag-MOFs material obtained in step S2, 0.3 parts of the coupling agent, 0.1 parts of the coloring agent, and 0.5 parts of the additional additive to obtain an ingredient mixture. The ingredient mixture is subjected to a milling reaction for 3 hours followed by a spray granulation, thereby obtaining the artificial waterproof granular material including a plurality of granules with a average size of 0.75 mm.

### Example 2

In this example, an artificial waterproof granular material is formed from the following ingredients in parts by weight: 7.5 parts of a polyurethane resin, 4 parts of a modified polyurethane resin, 92 parts of a filler, 0.5 parts of a plasticizer, 0.5 parts of a coupling agent, 0.3 parts of a coloring agent, 2 parts of a Ag-MOFs (metal organic frameworks material), and 1.2 parts of an additional additive.

The filler is the quartz sand. The plasticizer is a blend of chlorinated paraffin, mineral oil, and butyl benzyl phthalate in a mass ratio of 3:1:1. The coupling agent is heptadecafluoroalkyltriethoxysilane. The coloring agent is fluorescent green. The additional additive is perfluoro-group-containing polyhedral oligomeric silsesquioxane.

In this example, the method for making the artificial waterproof granular material comprises the following steps.

Step S1: 12 parts of polyethylene glycol, 5 parts of ethylene glycol, 2.5 parts of 1H,1H,9H,9H-perfluoro-1,9-nonanediol, and 3 parts of triethylenediamine are weighed in parts by weight, stirred to be mixed uniformly, heated to a temperature of 95° C., and slowly dropwise added with an appropriate amount of diphenylmethane diisocyanate, and then the temperature is kept until the percentage by weight of —NCO reaches zero, to obtain the modified polyurethane.

Step S2: 2,4,6-tris(4-carboxyphenoxy)-1,3,5-triazine of formula I, as an organic MOF ligand, is dissolved into 1 L of solvent dimethylformamide (DMF) to a concentration of 0.1 mol/L, and then mixed with 1.1 L of aqueous solution of silver nitrate in a concentration of 0.3 mol/L, thereby obtaining a liquid mixture. The liquid mixture is subjected to a reflux condensation reaction at 120° C. for 12 hours, cooled to room temperature, filtered, repeatedly washed with acetone, and dried to obtain the Ag-MOFs material.

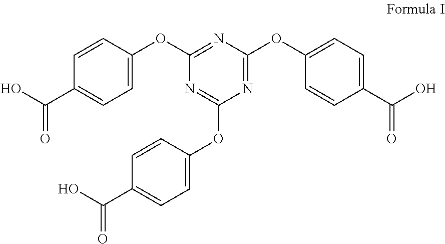 [SMILES: O=C(O)c1ccc(Oc2nc(Oc3ccc(C(=O)O)cc3)nc(Oc3ccc(C(=O)O)cc3)n2)cc1]

Step S3: 4 parts of the modified polyurethane resin obtained in step 51, 7.5 parts of the polyurethane resin, and 0.5 parts of the plasticizer are weighed in parts by weight, mixed uniformly, and then added with 92 parts of the filler, 2 parts of the Ag-MOFs material obtained in step S2, 0.5 parts of the coupling agent, 0.3 parts of the coloring agent, and 1.2 parts of the additional additive to obtain an ingredient mixture. The ingredient mixture is subjected to a milling reaction for 6 hours followed by a spray granulation, thereby obtaining the artificial waterproof granular material including a plurality of granules with a average size of 0.75 mm.

### Example 3

In this example, an artificial waterproof granular material is formed from the following ingredients in parts by weight: 9.5 parts of a polyurethane resin, 5 parts of a modified polyurethane resin, 95 parts of a filler, 0.7 parts of a plasticizer, 0.7 parts of a coupling agent, 0.8 parts of a coloring agent, 2.5 parts of a Ag-MOFs (metal organic frameworks material), and 2.0 parts of an additional additive.

The filler is the quartz sand. The plasticizer is a blend of chlorinated paraffin, mineral oil, and butyl benzyl phthalate in a mass ratio of 3:1:1. The coupling agent is tridecafluoroalkyltrimethoxysilane. The coloring agent is phthalein cyanine. The additional additive is perfluoro-group-containing polyhedral oligomeric silsesquioxane.

In this example, the method for making the artificial waterproof granular material comprises the following steps.

Step S1: 15 parts of polyethylene glycol, 7 parts of ethylene glycol, 3 parts of 1H,1H,9H,9H-perfluoro-1,9-nonanediol, and 5 parts of triethylenediamine are weighed in parts by weight, stirred to be mixed uniformly, heated to a temperature of 95° C., and slowly dropwise added with an appropriate amount of diphenylmethane diisocyanate, and then the temperature is kept until the percentage by weight of —NCO reaches zero, to obtain the modified polyurethane.

Step S2: 2,4,6-tris(4-carboxyphenoxy)-1,3,5-triazine of formula I, as an organic MOF ligand, is dissolved into 1 L of solvent dimethylformamide (DMF) to a concentration of 0.15 mol/L, and then mixed with 1 to 1.1 L of aqueous solution of silver nitrate in a concentration of 0.45 mol/L, thereby obtaining a liquid mixture. The liquid mixture is subjected to a reflux condensation reaction at 160° C. for 12 hours, cooled to room temperature, filtered, repeatedly washed with acetone, and dried to obtain the Ag-MOFs material.

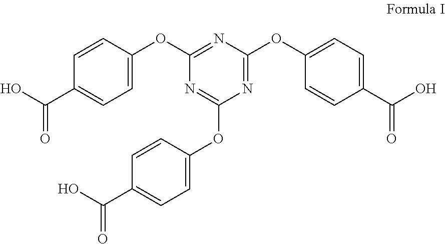 [SMILES: O=C(O)c1ccc(Oc2nc(Oc3ccc(C(=O)O)cc3)nc(Oc3ccc(C(=O)O)cc3)n2)cc1]

Step S3: 5 parts of the modified polyurethane resin obtained in step 51, 9.5 parts of the polyurethane resin, and 0.7 parts of the plasticizer are weighed in parts by weight, mixed uniformly and then added with 95 parts of the filler, 2.5 parts of the Ag-MOFs material obtained in step S2, 0.7 parts of the coupling agent, 0.8 parts of the coloring agent, and 2.0 parts of the additional additive to obtain an ingredient mixture. The ingredient mixture is subjected to a milling reaction for 8 hours followed by a spray granulation, thereby obtaining the artificial waterproof granular material including a plurality of granules with a average size of 0.75 mm.

### Example 4

The ingredient composition and the making method of the artificial waterproof granular material in this example are substantially the same as those in Example 1, except that the addition additive further includes 0.2 parts of an antioxidant and 0.3 parts of a preservative. The antioxidant is hindered phenol antioxidant 1010. The preservative is potassium sorbate.

### Example 5

The ingredient composition and the making method of the artificial waterproof granular material in this example are substantially the same as those in Example 1, except that the filler is silicon dioxide particle, the addition additive further includes 0.2 parts of an antioxidant and 0.3 parts of a preservative, and the coloring agent is lemon yellow. The antioxidant is hindered phenol antioxidant 1010. The preservative is potassium sorbate.

### Example 6

The ingredient composition and the making method of the artificial waterproof granular material in this example are substantially the same as those in Example 1, except that the filler is titanium dioxide particle, and the addition additive further includes 0.2 parts of an antioxidant and 0.3 parts of a preservative. The antioxidant is hindered phenol antioxidant 3114. The preservative is ascorbic acid.

### Example 7

The ingredient composition and the making method of the artificial waterproof granular material in this example are substantially the same as those in Example 1, except that the filler is polyvinyl chloride particle, and the addition additive further includes 0.2 parts of an antioxidant and 0.3 parts of a preservative. The antioxidant is hindered phenol antioxidant 1076. The preservative is sodium benzoate.

### Example 8

The ingredient composition and the making method of the artificial waterproof granular material in this example are substantially the same as those in Example 1, except that the plasticizer is a blend of chlorinated paraffin, mineral oil, and TEHP in a mass ratio of 3:1:1.

### Example 9

The ingredient composition and the making method of the artificial waterproof granular material in this example are substantially the same as those in Example 1, except that the plasticizer is a blend of chlorinated paraffin, mineral oil, and DINCH in a mass ratio of 3:1:1.

### Comparative Example 1

The ingredient composition and the making method of the artificial granular material in this comparative example are substantially the same as those in Example 1, except that no modified polyurethane resin is added in this comparative example.

### Comparative Example 2

The ingredient composition and the making method of the artificial granular material in this comparative example are substantially the same as those in Example 1, except that no polyhedral oligomeric silsesquioxane is added in this comparative example.

### Comparative Example 3

The ingredient composition and the making method of the artificial granular material in this comparative example are substantially the same as those in Example 1, except that no Ag-MOFs material is added in this comparative example.

### Comparative Example 4

The ingredient composition and the making method of the artificial granular material in this comparative example are substantially the same as those in Example 1, except that nano-Ag instead of Ag-MOFs material in an equivalent amount is added in this comparative example.

Performance Test

The artificial waterproof granular material made in Examples 1 to 3 and Comparative Examples 1 to 4 are subjected to the performance test, and the results are shown in Table 1.

The resilience and the elongation are tested by using the CTM6000 universal tester (Shanghai Xieqiang Instrument).

Water Absorption Test:
100 g of the artificial waterproof granular material moulded into a self-supporting configuration is completely immersed into deionized water placed in a dark place for 24 h and then taken out. Thereafter, an absorbent paper is used to remove most water on the granular material, and the granular material is spread over in an oven and dried therein at 60° C. for 1 h. After drying, the granular material is taken out and weighed. The weight of the dried granular material is compared with the original weight (i.e., 100 g) of the granular material to obtain the water absorption rate of the granular material.

Humidity and Heat Resistance Test:
Samples of the artificial waterproof granular materials made in Examples 1 to 3 and Comparative Examples 1 to 4 are placed in an environment at a temperature of 80° C. with a relative humidity of 95% (RH). The samples are checked one time after 48 hours and then checked every 24 hours. The time when the apparent defect such as the crack and the color change is observed on the sample is used as the evaluation index.

Antibacterial Property Test:
Taking Gram-negative bacteria Escherichia coli and Gram-positive bacteria Staphylococcus aureus as evaluation objects, the antibacterial properties of the samples of the granular materials are tested by a shaking culture method. The bacterial suspension and the sample are mixed in a shaker and incubated for 24 h, and the change of bacterial concentration before and after incubation is detected under the ultraviolet wavelength of 600 nm, so as to evaluate the antibacterial properties of the samples of the granular materials.

Rubbing Resistance Test:
Samples are rubbed 2000 times with a rubbing tester, and the change of resilience of the sample before and after rubbing is used as the evaluation index.

TABLE 1

| | | | Water | Humidity | | |
|---|---|---|---|---|---|---|
| | Resilience, | Elongation,/ | absorption, | and heat | Antibacterial | Rubbing |
| | % | % | % | resistance, h | property, % | resistance |
| Example 1 | 108 | 157 | 0.62 | ≥168 | 98.2 | 1.6 |
| Example 2 | 111 | 160 | 0.61 | ≥168 | 97.9 | 1.5 |
| Example 3 | 113 | 166 | 0.63 | ≥168 | 98.1 | 1.8 |
| Comparative | 104 | 141 | 1.69 | 72 | 98.1 | 1.7 |
| Example 1 | | | | | | |
| Comparative | 101 | 160 | 0.76 | 120 | 95.6 | 2.1 |
| Example 2 | | | | | | |
| Comparative | 116 | 171 | 0.85 | ≥168 | 56.4 | 1.2 |
| Example 3 | | | | | | |
| Comparative | 114 | 166 | 0.68 | ≥168 | 87.6 | 1.8 |
| Example 4 | | | | | | |

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present disclosure.

The above-described embodiments are only several implementations of the present disclosure, and the descriptions are relatively specific and detailed, but they should not be construed as limiting the scope of the present disclosure. It should be understood by those of ordinary skill in the art that various modifications and improvements can be made without departing from the concept of the present disclosure, and all fall within the protection scope of the present disclosure. Therefore, the patent protection of the present disclosure shall be defined by the appended claims.

What is claimed is:

1. An artificial waterproof granular material, being formed from the following ingredients in parts by weight: 4.5 to 9.5 parts of a polyurethane resin, 3 to 5 parts of a modified polyurethane resin, 90 to 95 parts of a filler, 0.3 to 0.7 parts of a plasticizer, 0.3 to 0.7 parts of a coupling agent, 0.1 to 0.8 parts of a coloring agent, 1.5 to 2.5 parts of a metal organic frameworks material Ag-MOFs, and 0.5 to 2.0 parts of an additional additive.

2. The artificial waterproof granular material of claim 1, wherein the modified polyurethane resin is obtained by a polymerization reaction with polyethylene glycol, 1H,1H,9H,9H-perfluoro-1,9-nonanediol, and 4,4′-diphenylmethane diisocyanate as monomer ingredients and ethanediol as a chain extender in the presence of a catalyst.

3. The artificial waterproof granular material of claim 1, wherein the filler is selected from the group consisting of polyacrylonitrile plastic particle, ethylene-vinyl acetate copolymer particle, polystyrene particle, titanium dioxide, quartz sand, river sand, sea sand, silica sand, glass bead, glass sand, polyvinyl chloride particle, silicone hollow microsphere, ground marble, hollow microspheres, plastic microspheres, ceramic microspheres, glass microspheres, and any combination thereof.

4. The artificial waterproof granular material of claim 1, wherein the plasticizer is a blend of chlorinated paraffin, mineral oil, and an ester plasticizer.

5. The artificial waterproof granular material of claim 4, wherein the ester plasticizer is selected from the group consisting of terephthalate, phosphate, cyclohexanedicarboxylate, polyol ester, phthalate or any combination thereof.

6. The artificial waterproof granular material of claim 5, wherein the ester plasticizer is selected from the group consisting of dioctyl terephthalate, tris(2-ethylhexyl) phosphate, diisononyl 1,2-cyclohexanedicarboxylate, 2,2,4-trimethyl-1,3-pentanediol diisobutyrate, diethylene glycol dibenzoate, butyl benzyl phthalate, and any combination thereof.

7. The artificial waterproof granular material of claim 4, wherein a mass ratio of the chlorinated paraffin, the mineral oil, and the ester plasticizer is in a range of (2.5-3.5):(0.8-1.2):(0.8-1.2).

8. The artificial waterproof granular material of claim 1, wherein the coupling agent is selected from the group consisting of heptafluoroalkyltrimethoxysilane, heptafluoroalkyltriethoxysilane, tridecafluoroalkyltrimethoxysilane, tridecafluoroalkyltriethoxysilane, dodecafluoroalkyltrimethoxysilane, dodecafluoroalkyltriethoxysilane, and any combination thereof.

9. The artificial waterproof granular material of claim 1, wherein the coloring agent is selected from the group consisting of phthalocyanine blue, fluorescent green, cochineal red, gamboge, alizarin red, indigo, lemon yellow, roselle red, carbon black, titanium dioxide, and any combination thereof.

10. The artificial waterproof granular material of claim 1, wherein the additional additive is selected from the group consisting of an antioxidant, a preservative, a polyhedral oligomeric silsesquioxane, and any combination thereof.

11. The artificial waterproof granular material of claim 4, wherein the Ag-MOFs is self-assembled by 2,4,6-tris(4-carboxyphenoxy)-1,3,5-triazine and Ag ions via coordinate bonds.

12. The artificial waterproof granular material of claim 1, comprising a plurality of granules, wherein each of the granules comprises a core and a cohesive layer coated on the core, the core is formed by the filler, and the cohesive layer is formed by the polyurethane resin, the modified polyurethane resin, the plasticizer, the coupling agent, the coloring agent, the metal organic frameworks material Ag-MOFs, and the additional additive.

13. The artificial waterproof granular material of claim 12, wherein the granules have an average size of 0.5 mm to 1.5 mm.

14. A method for making a waterproof granular material, comprising:
mixing 3 to 5 parts by weight of a modified polyurethane resin, 4.5 to 9.5 parts by weight of a polyurethane resin, and 0.3 to 0.7 parts by weight of a coupling agent to obtain a resin mixture;
adding 90 to 95 parts by weight of a filler, 1.5 to 2.5 parts by weight of a Ag-MOFs material, 0.3 to 0.7 parts by weight of a coupling agent, 0.1 to 0.8 parts by weight of a coloring agent, and 0.5 to 2.0 parts by weight of an additional additive into the resin mixture to obtain an ingredient mixture; and
subjecting the ingredient mixture to a ball milling reaction for 1 to 8 hours followed by a spray granulation to obtain the artificial waterproof granular material.

15. The method of claim 14, wherein the modified polyurethane resin is obtained by a polymerization reaction with polyethylene glycol, 1H,1H,9H,9H-perfluoro-1,9-nonanediol, and 4,4′-diphenylmethane diisocyanate as monomer ingredients and ethanediol as a chain extender in the presence of a catalyst.

16. The method of claim 14, wherein the Ag-MOFs is self-assembled by 2,4,6-tris(4-carboxyphenoxy)-1,3,5-triazine and Ag ions via coordinate bonds.

17. The method of claim 14, wherein the filler is selected from the group consisting of polyacrylonitrile plastic particle, ethylene-vinyl acetate copolymer particle, polystyrene particle, titanium dioxide, quartz sand, river sand, sea sand, silica sand, glass bead, glass sand, polyvinyl chloride particle, silicone hollow microsphere, ground marble, hollow microspheres, plastic microspheres, ceramic microspheres, glass microspheres, and any combination thereof.

18. The method of claim 14, wherein the plasticizer is a blend of chlorinated paraffin, mineral oil, and an ester plasticizer.

19. The method of claim 14, wherein the coupling agent is selected from the group consisting of heptafluoroalkyltrimethoxysilane, heptafluoroalkyltriethoxysilane, tridecafluoroalkyltrimethoxysilane, tridecafluoroalkyltriethoxysilane, dodecafluoroalkyltrimethoxysilane, dodecafluoroalkyltriethoxysilane, and any combination thereof.

20. The method of claim 14, wherein the additional additive is selected from the group consisting of an antioxidant, a preservative, a polyhedral oligomeric silsesquioxane, and any combination thereof.
